(19) United States
(12) Patent Application Publication
(10) Pub. No.: US 2019/0003454 A1
(43) Pub. Date: Jan. 3, 2019

(54) METHOD AND DEVICE FOR OPERATING A WIND TURBINE

(71) Applicant: FOS4X GMBH, München (DE)

(72) Inventors: Mathias MÜLLER, München (DE); Mathias SCHUBERT, Rendsburg (DE); Manuel MAI, München (DE)

(21) Appl. No.: 16/062,627

(22) PCT Filed: Dec. 5, 2016
(86) PCT No.: PCT/EP2016/079761

§ 371 Date: Jun. 14, 2018

(30) Foreign Application Priority Data
Dec. 16, 2015 (DE) 10 2015 121 981.6

(51) Int. Cl. F03D 7/02; F03D 1/06; F03D 17/00

(52) U.S. Cl. CPC F03D 7/0224; F03D 1/0633; F03D 17/00; F05B 2220/30; F05B 2240/221; F05B 2260/74; F03D 7/04; F05B 2270/305; F05B 2270/402; F05B 2270/804; F05B 2270/328; F05B 2270/32; F05B 2270/321; F05B 2260/80

(57) ABSTRACT

The invention relates to a method for operating a wind turbine. The method comprises measuring a torsion between a first point (10) of a rotor blade (100) of a wind turbine and a second point (12) spaced apart from the first point, and determining at least one parameter, in particular an actual value of the at least one parameter, of the wind turbine based on the measured torsion, wherein the at least one parameter is selected from the group comprising an angle of attack of the rotor blade (100), a pitch angle, a wind speed, an angle of incidence, and a flow speed.

The disclosure relates to a method and a device for operating a wind turbine, and in particular to a method that uses a torsion measurement in a rotor blade of the wind turbine in order to determine and/or set parameters, for example operating parameters of the wind turbine.

### BACKGROUND

Operating parameters of wind turbines are in many cases checked and adjusted continuously or at specified intervals of time. Many mechanical plant components are subjected to static and dynamic loads so that a target setting of an angle of attack of a rotor blade, for example, may deviate from an actual angle of attack. A regulation or control of such operating parameters, for example, the angle of attack, thus cannot be performed in a precise manner, since only the target setting is known in many cases.

Therefore, there is the need to further improve a method and device for operating a wind turbine. There is the particular need to further improve a regulation or control of certain operating parameters of wind turbines.

### SUMMARY

The task of the present disclosure is to propose a method and a device for operating a wind turbine which allow operating parameters to be regulated or controlled precisely. The particular task of the present disclosure is to determine actual values of operating parameters in a reliable manner.

This task is solved by the subject matter of the independent claims.

According to embodiments of the present disclosure, a method for operating a wind turbine is proposed. The method includes measuring a torsion between a first point of a rotor blade of the wind turbine and a second point spaced apart from the first point, and determining at least one parameter of the wind turbine based on the measured torsion. The parameter is selected form the group including an angle of attack of the rotor blade, a pitch angle, a wind speed, an angle of incidence, a flow speed and any combination thereof.

According to a further aspect of the present disclosure, a method for operating a wind turbine is proposed. The method includes measuring a torsion between a first point of a rotor blade of the wind turbine and a second point spaced apart from the first point, and performing a frequency analysis of a measurement signal indicating the torsion.

According to another aspect of the present disclosure, a device for operating a wind turbine is proposed. The device includes one or more torsion sensors and a control device that is arranged to execute the method according to the embodiments described herein.

Preferred optional embodiments and particular aspects of the disclosure will result from the dependent claims, the drawings, and the present specification.

According to the embodiments of the present disclosure, a torsion measurement is performed in rotor blades of wind turbines. For example, torsion sensors can be provided to measure torsions in rotor blades at a plurality of cross-sections and/or radii. The measured torsion allows conclusions to be drawn as to actual settings and values as well as operating states such as, for instance angles of attack, angles of incidence, flow speeds, and fluttering movements of the rotor blade. A precise setting of operating parameters such as, for instance, the angle of attack, may be performed based on the determined actual settings and values and/or operating states. An efficiency of the wind turbine can be improved.

### BRIEF DESCRIPTION OF THE DRAWINGS

Exemplary embodiments of the disclosure are illustrated in the Figures and will be described in more detail below. Shown are in:

FIG. 1 a schematic representation of a rotor blade with two points for measuring torsion according to embodiments of the present disclosure,

FIG. 2 a schematic representation of a rotor blade with a measurement of torsion by segments according to embodiments of the present disclosure,

FIG. 3 a schematic representation of a rotor blade with two points for measuring torsion according to further embodiments of the present disclosure, and

FIG. 4 a schematic representation of a torsion sensor which can be used according to embodiments of the present disclosure for measuring the torsion.

### EMBODIMENTS OF THE DISCLOSURE

Unless otherwise stated, identical reference numerals will be used below for identical elements and elements of identical action.

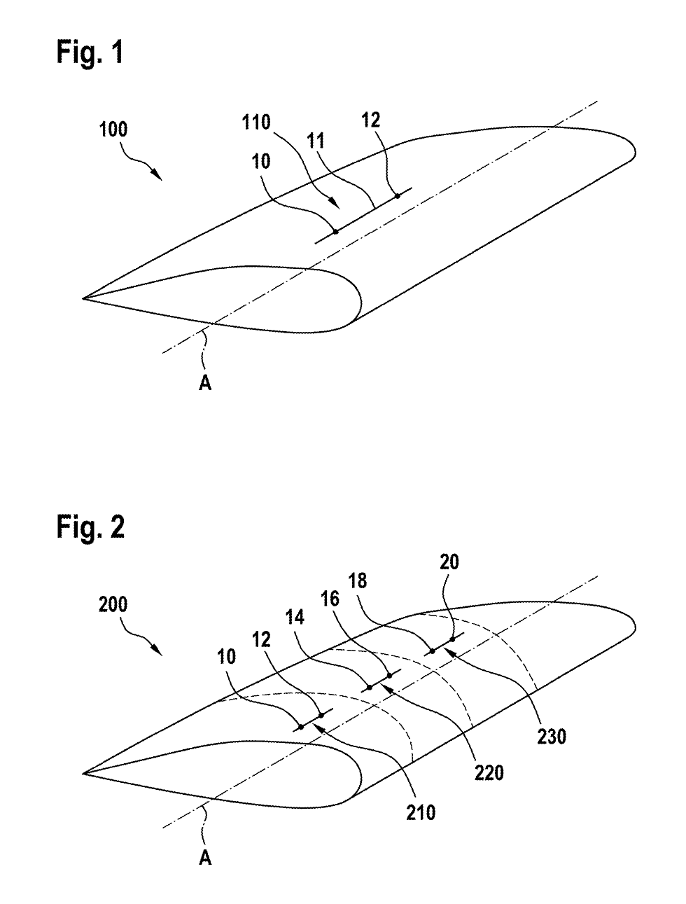

FIG. 1 shows a schematic representation of a rotor blade 100 with two points for measuring a torsion according to embodiments of the present disclosure. The torsion can be measured using one or more torsion sensors 110.

The torsion sensor 110 includes a first point 10 and a second point 12 which are interconnected by a light guide fiber 11. A torsion of the rotor blade 100 about a torsion axis causes the angle of rotation of the light guide fiber 11 to be changed from the first point 10 with respect to the second point 12. The change of the angle of rotation causes a change in polarization of light traveling through the light guide fiber 11. From the change in polarization, the change of the angle of rotation and thus the torsion of the rotor blade 100 can be determined. According to embodiments, the torsion axis and/or the light guide fiber 11 extend along a longitudinal extension A of the rotor blade 100, for example, substantially in parallel thereto. According to embodiments, the longitudinal extension A may correspond to a rotor blade axis or may be a rotor blade axis.

According to embodiments which can be combined with other embodiments described herein, the torsion sensor 110 is integrated in the rotor blade 100 or disposed on an upper surface of the rotor blade 100. The torsion sensor 110 is in particular mechanically coupled to the rotor blade 100, so that a torsion of the rotor blade 100 about the torsion axis causes the angle of rotation of the light guide fiber 11 to be changed from the first point 10 with respect to the second point 12.

According to an aspect of the disclosure, a method for operating a wind turbine includes measuring a torsion between the first point 10 of the rotor blade 100 of the wind turbine and the second point 12 spaced apart from the first point, and determining at least one parameter, in particular an actual value of the at least one parameter, of the wind turbine based on the measured torsion. The at least one parameter is selected from the group including an angle of attack of the rotor blade, a pitch angle, a wind speed, an angle of incidence and a flow speed.

Parameters of the wind turbine are variables with regard to an operation of the wind turbine. The parameters may be operating parameters of the wind turbine or include operating parameters, for example. Operating parameters may be, for instance, the angle of attack of the rotor blade or the pitch angle. The angle of attack is typically defined with respect to a reference plane. The pitch angle may indicate an angular position of the rotor blade 100 with respect to a hub to which the rotor blade is mounted to be rotatable. The angle of incidence may indicate an angle between a plane defined by the rotor blade 100 and a wind direction. The flow speed may indicate a relative speed or a relative mean speed at which the air impinges on the rotor blade. The wind speed may indicate an absolute wind speed.

The parameters of the wind turbine may be determined from the measured torsion, for example, by comparison to predefined values. Predefined values which may originate from simulations and/or tests and/or empirical values derived from the operation of the wind turbine, may be stored, for example. Additionally, or alternatively, algorithms may be used to convert the measured values of the torsion into the parameters.

According to an aspect, the torsion or a measurement signal indicating the torsion is used in a control or regulation process of the wind turbine. According to an aspect, the torsion is measured continuously and used continuously in the control or regulation process. “Continuously” designates both a continuous measurement, for example in an analog regulation method, and a continuous sampling of the measurement variable, for example in a digital regulation method. The measurement of the torsion of the rotor blade by means of the methods and devices described herein, is possible in a simple manner, which allows the control or regulation process to be implemented reliably.

The measured torsion in particular allows a conclusion as to actual settings and values as well as to operating states such as, for instance, the angle of attack, angle of incidence, wind speed, pitch angle, flow speeds, and fluttering movements of the rotor blade 100. A precise setting of operating parameters such as, for instance the angle of attack and/or the pitch angle may be performed based on the determined real (actual) settings and values and/or operating states. An efficiency of the wind turbine can be improved.

In some embodiments, the method further includes comparing the at least one parameter to at least one target value of the at least one parameter. The actual value, determined from the torsion, of the at least one parameter indicating a real value of the at least one parameter may deviate from a target value, for example. A deviation such as, for instance a difference between the actual value and the target value can be determined. In typical embodiments, the method may further include setting the angle of attack and/or the pitch angle of the rotor blade 100 based on the measured torsion, in particular based on the comparison to the at least one target value. Operating parameters of the wind turbine can be determined with improved precision and adjusted optionally.

According to a further aspect of the present disclosure, which can be optionally combined with the method explained above, a method for operating a wind turbine is proposed which includes measuring a torsion between a first point of a rotor blade of a wind turbine and a second point spaced apart from the first point, and performing a frequency analysis of a measurement signal indicating the torsion. The torsion may in particular be measured continuously or at predefined intervals of time over a period of time in order to obtain the measurement signal. The frequency analysis of the measurement signal may provide information on a temporal change of the torsion. A temporal change of the at least one parameter may be determined by means of the frequency analysis, for example. The frequency analysis typically includes a Fourier analysis.

In several embodiments, the method may further include determining a fluttering movement of the rotor blade based on the frequency analysis. The fluttering movement may be a periodic or non-periodic vibration of the rotor blade 100. When an oscillation is present in the measurement signal and/or in the temporal course of the determined parameter, for example, the angle of attack, conclusions may be drawn as to a fluttering movement of the rotor blade 100. The presence of a fluttering movement may be determined when the oscillation corresponds to a predefined pattern. The oscillation may, for instance, exhibit one ore more predefined frequencies (frequency components) and/or amplitudes which indicate the presence of a fluttering movement. According to embodiments, one or more operating parameters such as, for instance an angle of attack and/or a pitch angle of the rotor blade 100 may be adjusted or changed so as to reduce or stop the fluttering movement.

According to embodiments which can be combined with other embodiments described herein, the performing of the frequency analysis may include determining a natural frequency, in particular a natural torsional frequency. The method may include determining an impact of the rotor blade 100 by foreign material based on the natural torsional frequency. An impact of the rotor blade 100 by foreign material may be determined, for example, when the natural frequency is within a predefined frequency range or corresponds to a predefined frequency. When the natural frequency is outside the predefined frequency range, it may be determined that an impact of the rotor blade 100 by foreign material is not given.

The foreign material may be ice or an ice deposit, for example. According to embodiments, one or more operating parameters, such as, for instance, an angle of attack and/or a pitch angle of the rotor blade may be adjusted or changed when there is an impact by foreign material. Thus, an impact by foreign material may be addressed effectively, for example, to maintain a performance of the wind turbine and/or to avoid a damage to the wind turbine.

FIG. 2 shows a schematic representation of a rotor blade 200 with a measurement of torsion by segments according to embodiments of the present disclosure.

According to some embodiments, which can be combined with other embodiments described herein, the torsion measurement is performed using at least one further point on the rotor blade 200. For example, at least one third point may be present. A first torsion measurement may be performed between the first point 10 and the second point 12. A further torsion measurement may be performed between the second point 12 and the third point.

In some embodiments, the rotor blade 200 may be subdivided into two or more segments. The torsion measurement may be performed in at least two segments of the two or more segments of the rotor blade 200. The first point 10 and the second point 12 may be located in a first segment 210 of the rotor blade 200, for example. At least one further point, and preferably at least two further points, may be disposed in a second segment 220 of the rotor blade 200.

Typically, the torsion measurement may be performed between at least two further points on the rotor blade 200. The first segment 210 of the two or more segments may include the first point 10 and the second point 12, for example. The second segment 220 of the two or more segments may include a third point 14 and a fourth point 16. A third segment 230 of the two or more segments may include a fifth point 18 and a sixth point 20. Typically, a first torsion sensor may be present in the first segment 210, a second torsion sensor may be present in the second segment 220, and a third torsion sensor may be present in the third segment 230.

In some embodiments, each segment of the two or more segments may have a torsion sensor of its own as described, for instance, with reference to FIG. 4. In other embodiments, a single torsion sensor may be present which extends across the two or more segments.

According to embodiments, the method may include determining the flow speed by segments. A respective flow speed may be determined for each segment of the two or more segments, for example. In some embodiments, the angle of attack and/or the pitch angle of the rotor blade 200 may be set by segments. The angle of attack and/or the pitch angle may be set independently for at least some segments of the two or more segments, in particular based on the (local) flow speed determined for the respective segment. The setting of the angle of attack by segments may be performed by local actuators (e.g. electric motors and/or pneumatic devices) associated to the individual segments.

The determining of the torsion by segments allows an angle of attack and/or a pitch angle of the rotor blade to be set or changed more efficiently, for example. This allows a performance of the wind turbine to be improved.

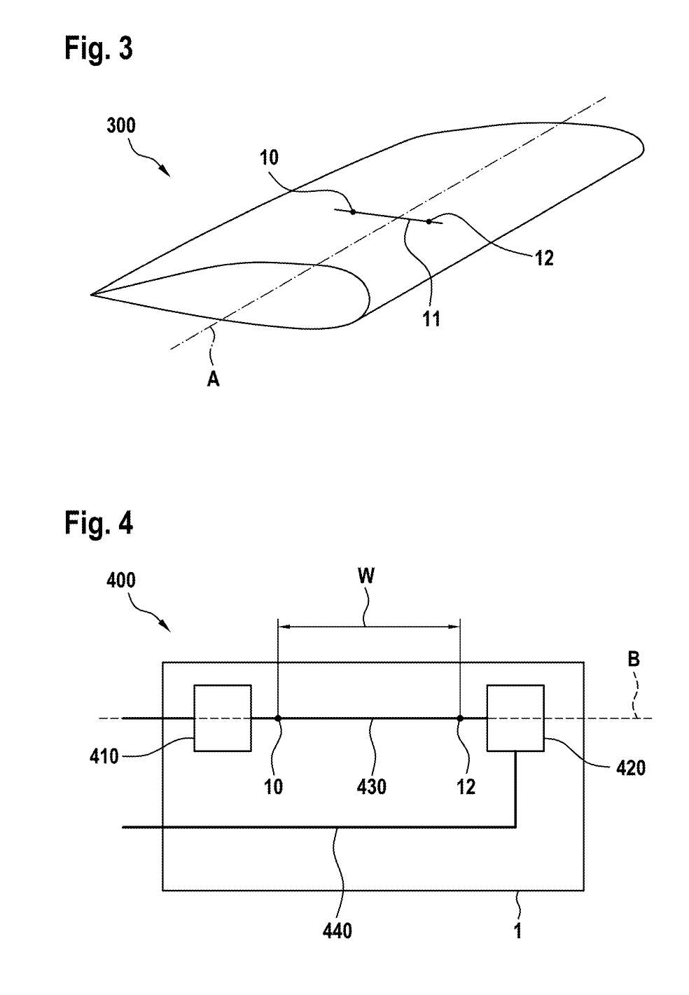

FIG. 3 shows a schematic representation of a rotor blade 300 with two points for measuring torsion according to further embodiments of the present disclosure.

In the embodiments shown in FIGS. 1 and 2, the light guide fiber 11, and in particular the longitudinal extension of the light guide fiber 11 of the torsion sensor is arranged along the longitudinal extension A of the rotor blade.

The light guide fiber 11 of the torsion sensor may be arranged, for instance, substantially in parallel to the longitudinal extension of the rotor blade.

In the example of FIG. 3, the light guide fiber 11, and in particular a longitudinal extension of the light guide fiber 11 of the torsion sensor is arranged substantially perpendicular to the longitudinal extension A of the rotor blade 300.

The present disclose, however, is not restricted thereto, and the light guide fiber 11 of the torsion sensor may have any orientation with respect to the longitudinal extension A of the rotor blade. The light guide fiber 11 and the longitudinal extension A of the rotor blade may include any angle in a range from 0° (parallel) to 90° (perpendicular), for example.

According to embodiments which can be combined with other embodiments described herein, a device for operating a wind turbine is proposed. The device includes one or more torsion sensors and a control device which is arranged to execute the method according to anyone of the embodiments described herein. The wind turbine or a control device of the wind turbine may include the device, for example.

FIG. 4 shows a schematic representation of a torsion sensor 400 which can be used according to embodiments of the present disclosure for measuring the torsion.

The torsion sensor 400 includes a source 410 of polarized light including a polarizing source of light, which emits polarized light, or a polarizer which is optically coupled to the source of light. The torsion sensor 400 including a first light guide fiber 430 (indicated in FIGS. 1 to 3 by reference numeral “11”) which is optically coupled to the output of the source 410 and attached to the rotor blade 1 (also referred to as “measurement object”) at the first point 10 and at the second point 12 in such a manner that a torsion of the rotor blade 1 about a torsion axis B causes the angle of rotation of the first light guide fiber 430 to be changed from the first point 10 with respect to the second point 12.

The torsion sensor 400 includes a second light guide fiber 440 which is connected to the first light guide fiber 430 at the second point 12 or with respect to the light path from the source behind the second point 12 for feeding the light to an evaluation unit (not shown). The evaluation unit may be the device which is arranged to execute the methods according to the embodiments described herein. The first light guide fiber 430 has, at least in some areas, a fiber that is not polarization maintaining. The second light guide fiber 440 is a polarization maintaining fiber. In FIG. 4, the distance between the first point 10 and the second point 12 is referred to by reference symbol “W”.

The operation for measuring the torsion in the method according to the embodiments described herein uses the torsion sensor 400 described above and includes providing the first light guide fiber 430 between the first point 10 and the second point 12 of the rotor blade 1 in such a manner that a torsion of the rotor blade 1 about the torsion axis B causes the angle of rotation of the first light guide fiber 430 to be changed from the first point 12 with respect to the second point 12, wherein the first light guide fiber 430 has, at least in some areas, a fiber that does not maintain polarization. The method includes providing the second light guide fiber 440 which is connected to the first light guide fiber 430 at the second point 12 or with respect to a light path from the first point 10 to the second point 12 behind the second point 12, and which leads away from the second point 12, the second light guide fiber 440 being in particular a polarization maintaining fiber.

The method further includes radiating, into the first light guide fiber 430, polarized light having a known entering polarization orientation, detecting an exiting polarization orientation of the light exiting the second light guide fiber 440, and evaluating the exiting polarization orientation in relation to the entering polarization orientation for determining the torsion.

In the illustrated embodiments, the source 410 is itself disposed on the rotor blade 1. However, the disclosure is not restricted thereto. It is in particular also possible for the source 410 to be disposed away from the rotor blade 1 and to supply the polarized light to the first light guide fiber 430 by means of an auxiliary light guide fiber.

The first light guide fiber 430 is optically connected to the source 410. Polarized light exiting from the source 410 can be optically applied to the first light guide fiber 430. The first light guide fiber 430 is attached to the rotor blade 1 at the first point 10 and the second point 12 in such a manner that a torsion of the rotor blade 1 about the torsion axis B causes the angle of rotation of the first light guide fiber 430 to be changed from the first point 10 with respect to the second point 12. The torsion axis B does not necessarily coincide with an actual geometrical axis of the rotor blade 1 or the like, such as, for instance, the longitudinal extension (indicated in FIGS. 1 to 3 by the reference symbol “A”) of the rotor blade. Rather, the torsion axis B is an imaginary line through the rotor blade 1 or at the surface of the rotor blade 1, about which a torsion of the rotor blade 1 to be measured takes place, wherein the torsion to be measured is reflected in a change of the angle of rotation between the first point 10 of the first light guide fiber 430 and the second point 12.

In the illustrated embodiment, a first end of the second light guide fiber 440 is connected to an end of the first light guide fiber 430 behind the second point 12 by means of a measurement connection device 420. Usually, the measurement connection device 420 is a light guide splice but is not restricted thereto. A connection by means of suitable light guide plugs or the like is also conceivable, provided that these will not give rise to any unknown change of the polarization orientation. The second light guide fiber 440 is configured to supply the light to the evaluation unit.

During operation of the torsion sensor 400, polarized light is supplied to the first light guide fiber 430 at its first end. Due to the attachment between the first point 10 and the second point 12, a torsion of the rotor blade 1 is transformed into a torsion of the first light guide fiber 430. The torsion angle is mapped as an angle between the fiber and the polarization plane. As a consequence of the properties of the first light guide fiber 430 of not maintaining polarization, a torsion of the rotor blade 1 about the torsion axis B results in a rotation of the polarization plane between the first end of the first light guide fiber 430 and the second end of the first light guide fiber 430. The first light guide fiber 430 thus functions as a fiber-optic sensor.

According to an aspect, the torsion sensor 400 is at least in part disposed on a surface of the rotor blade 1. According to an aspect, the first point 10 and/or the second point 12 are in particular disposed on a surface of the rotor blade 1. This may result in a simple assembly and a simple exchangeability of the torsion sensor 400, for example, for maintenance purposes. According to further embodiments, the torsion sensor 400 is integrated in the rotor blade. For example, the torsion sensor 400 is embedded in the rotor blade.

The torsion sensor 400 may include an evaluation unit, for instance, the device according to the embodiments described herein which is arranged to execute the method described herein. The evaluation unit is configured to output, as a function of a detected polarization state, a corresponding signal. The signal is appropriately coded. An analog or a digital control signal containing information on the detected polarization state will be output. The evaluation unit also keeps information about the polarization state of the light radiated into the first point 10 of the first light guide fiber 430. A comparison of the polarization state of the light radiated into the first point 10 of the first light guide fiber 430 to the polarization state of the light coded in the signal allows conclusions to be drawn as to the torsion of the rotor blade 1.

According to embodiments of the present disclosure, torsion measurement is performed in rotor blades of wind turbines. Torsion sensors may be provided, for example, to measure torsions in rotor blades at a plurality of cross-section and/or radii. The measured torsion allows conclusions to be drawn on actual settings and values as well as operating states such as, for instance, angles of attack, angles of incidence, flow speeds and fluttering movements of the rotor blade. A precise setting of operating parameters such as, for instance, the angle of attack may be performed based on the determined actual settings and values and/or operating states. An efficiency of the wind turbine can be improved.

1. A method for operating a wind turbine, comprising:
measuring a torsion between a first point of a rotor blade of a wind turbine and a second point spaced apart from the first point, in particular by using a torsion sensor which is integrated in the rotor blade or disposed on the surface of the rotor blade; and
determining at least one parameter, in particular an actual value of the at least one parameter, of the wind turbine based on the measured torsion, wherein the at least one parameter is selected from the group comprising an angle of attack of the rotor blade, a pitch angle, a wind speed, an angle of incidence, and a flow speed.

2. The method according to claim 1, further comprising:
comparing the at least one parameter to at least one target value of the at least one parameter.

3. The method according to claim 1, further comprising:
setting the angle of attack and/or the pitch angle of the rotor blade based on the measured torsion, in particular based on the comparison to the at least one target value.

4. A method for operating a wind turbine, comprising:
measuring a torsion between a first point of a rotor blade of a wind turbine and a second point spaced apart from the first point; and
performing a frequency analysis of a measurement signal indicating the torsion.

5. The method according to claim 4, comprising:
determining a fluttering movement of the rotor blade based on the frequency analysis.

6. The method according to claim 4, wherein performing the frequency analysis comprises:
determining a natural torsional frequency.

7. The method according to claim 6, further comprising:
determining an impact of the rotor blade by foreign material based on the natural torsional frequency.

8. The method according to claim 1, wherein the torsion measurement is performed using at least one further point on the rotor blade, wherein, in particular, the torsion measurement is performed between at least two further points on the rotor blade.

9. The method according to claim 8, wherein the torsion measurement is performed in at least two segments of the rotor blade, wherein the first point and the second point are located in a first segment of the rotor blade, and wherein at least one further point is located in a second segment of the rotor blade.

10. The method according to claim 9, further comprising:
determining a flow speed by segments.

11. The method according to claim 9, further comprising:
setting an angle of attack and/or pitch angle of the rotor blade by segments.

12. The method according to claim 11, wherein the setting of the angle of attack by segments is performed by local actuators associated to the individual segments.

13. The method according to claim 1, wherein measuring the torsion comprises:
providing a first light guide fiber between the first point and the second point of the rotor blade in such a manner that a torsion of the rotor blade about a torsion axis causes the angle of rotation of the first light guide fiber to be changed from the first point with respect to the second point, wherein, in particular, the first light guide fiber has, at least in some areas, a fiber that is not polarization maintaining;
providing a second light guide fiber which is connected to the first light guide fiber at the second point or with respect to a light path from the first point to the second point behind the second point, and which leads away from the second point, the second light guide fiber being in particular a polarization maintaining fiber;
radiating polarized light having a known entering polarization orientation into the first light guide fiber;
detecting an exiting polarization orientation of the light exiting the second light guide fiber; and
evaluating the exiting polarization orientation in relation to the entering polarization orientation for determining the torsion.

14. A device for operating a wind turbine, comprising:
one or more torsion sensors; and
a control device that is arranged to execute the method according to claim 1.
